(19) United States
(12) Patent Application Publication
(10) Pub. No.: US 2010/0304744 A1
(43) Pub. Date: Dec. 2, 2010

(54) METHOD AND APPARATUS FOR PERFORMING SEARCHES WITH MULTIPLE RECEIVE DIVERSITY (RXD) SEARCH MODES

(75) Inventors: An-Swol C. Hu, San Diego, CA (US); Jittra Jootar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/789,263

(22) Filed: May 27, 2010

Related U.S. Application Data
(60) Provisional application No. 61/182,544, filed on May 29, 2009.

(51) Int. Cl. H04L 27/06; H04W 24/00

(52) U.S. Cl. 455/434; 375/343

(57) ABSTRACT

Techniques for performing searches by a user equipment (UE) equipped with multiple receive antennas are described. In an aspect, the UE may support multiple receive diversity (R×D) search modes. Each R×D search mode may be different from each remaining R×D search mode in how correlation is performed, how correlation results are combined, and/or how search results are reported for the multiple receive antennas. The UE may select an R×D search mode from among the multiple R×D search modes and may perform at least one step of a search in accordance with the selected R×D search mode. In another aspect, the UE may perform a search with interference cancellation to detect cell(s). The UE may determine multiple complex weights for multiple receive antennas such that signals from interfering cells can be attenuated. The UE may perform a search to detect cell(s) using the complex weights.

### CLAIM OF PRIORITY UNDER 35 U.S.C. §119

The present application for patent claims priority to Provisional Application No. 61/182,544 entitled “METHOD AND APPARATUS FOR PERFORMING SEARCHES WITH MULTIPLE RECEIVE DIVERSITY (R×D) SEARCH MODES” filed May 29, 2009, and assigned to the assignee hereof and hereby expressly incorporated by reference herein.

### BACKGROUND

I. Field

The present disclosure relates generally to communication, and more specifically to techniques for searching for cells in a wireless communication system.

II. Relevant Background

Wireless communication systems are widely deployed to provide various communication services such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of cells that can support communication for a number of user equipments (UEs). A UE may be within the coverage of one or more cells at any given moment. The UE may have just been powered on or may have lost coverage and thus may not know which cells are within range. The UE may perform a search to detect cells and to acquire timing and other information for the detected cells. It may be desirable to perform the search in a manner to obtain good performance, e.g., to detect as many cells as possible.

### SUMMARY

Techniques for performing searches by a UE equipped with multiple receive antennas are described herein. In an aspect, multiple receive diversity (R×D) search modes may be supported by the UE. Each R×D search mode may be different from each remaining R×D search mode in (i) how correlation is performed for the multiple receive antennas, (ii) how correlation results for the multiple receive antennas are combined, (iii) how search results are reported for the multiple receive antennas, or (iv) a combination thereof. In one design, the UE may select an R×D search mode from among multiple R×D search modes supported by the UE. The UE may then perform at least one step of a search in accordance with the selected R×D search mode. In another design, the UE may perform a first step of a search in accordance with a first R×D search mode and perform a second step of the search in accordance with a second R×D search mode.

In another aspect, a UE may perform a search with interference cancellation to cancel signals from interfering cells. In one design, the UE may determine multiple complex weights for multiple receive antennas such that signals from interfering cells can be attenuated. The UE may then perform a search to detect at least one cell with the multiple complex weights applied to the multiple receive antennas. For example, the UE may correlate input samples for each receive antenna with a scrambling code for a cell. The UE may multiply the correlation result for each receive antenna with a complex weight for that receive antenna. The UE may then combine the weighted correlation results for all receive antennas to obtain a combined correlation result. The UE may detect the cell based on the combined correlation result.

Various aspects and features of the disclosure are described in further detail below.

### BRIEF DESCRIPTION OF THE DRAWINGS

FIG. 1 shows a wireless communication system.

FIG. 2A shows an exemplary frame structure.

FIG. 2B shows exemplary transmission of synchronization and pilot channels.

FIG. 3 shows a block diagram of a Node B and a UE.

FIGS. 4 to 6 show a search processor for different R×D search modes.

FIGS. 7 and 8 show processes for performing a search by a UE.

FIG. 9 shows a process for performing a search with interference cancellation.

### DETAILED DESCRIPTION

The search techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The search techniques described herein may be used for the systems and radio technologies mentioned above as well as other systems and radio technologies. For clarity, certain aspects of the search techniques are described below for WCDMA, and 3GPP terminology is used in much of the description below.

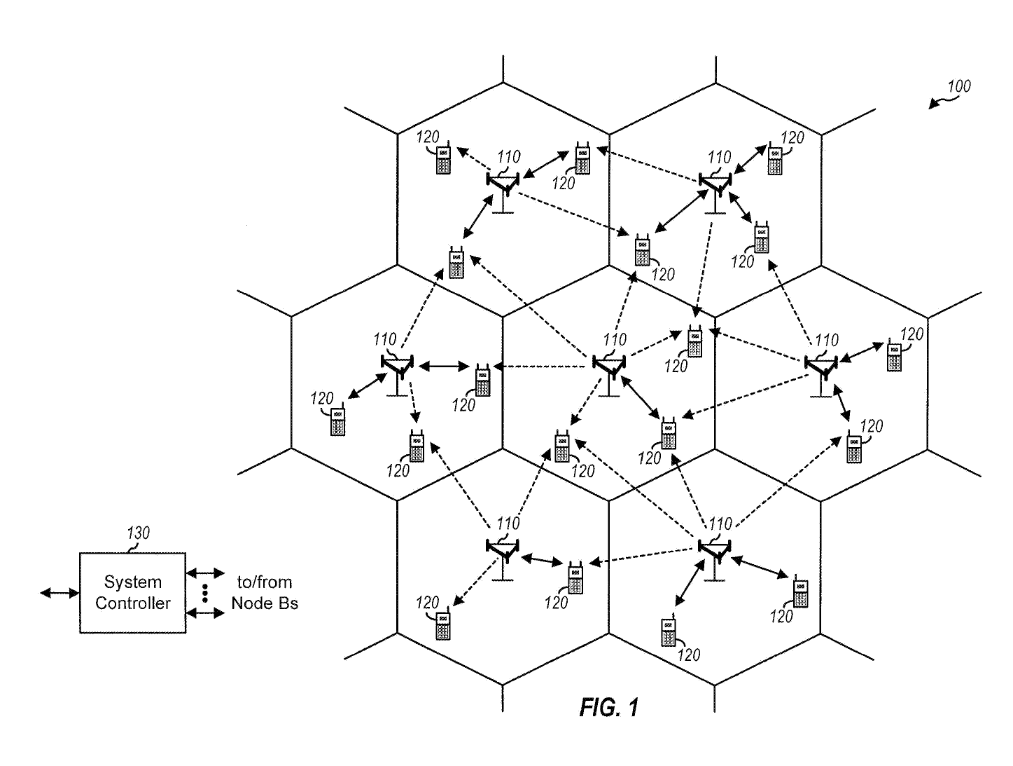

FIG. 1 shows a wireless communication system 100 with multiple Node Bs 110. A Node B is a station that communicates with the UEs and may also be referred to as a base station, an evolved Node B (eNode B), an access point, etc. Each Node B 110 provides communication coverage for a particular geographic area. The term “cell” can refer to a coverage area of a Node B and/or a Node B subsystem serving this coverage area, depending on the context in which the term is used. A Node B may serve one or multiple (e.g., three) cells.

UEs 120 may be dispersed throughout the system, and each UE may be stationary or mobile. A UE may also be referred to as a mobile station, a mobile equipment, a terminal, an access terminal, a subscriber unit, a station, etc. A UE may be a cellular phone, a personal digital assistant (PDA), a wireless communication device, a handheld device, a wireless modem, etc. A UE may communicate with a Node B via the downlink and uplink. The downlink (or forward link) refers to the communication link from the Node B to the UE, and the uplink (or reverse link) refers to the communication link from the UE to the Node B. In FIG. 1, a solid line with double arrows indicates communication between a Node B and a UE. A broken line with a single arrow indicates a UE receiving downlink signals from a Node B. A UE may perform a search based on the downlink signals transmitted by the Node Bs.

A system controller 130 may couple to the Node Bs 110 and may provide coordination and control for these Node Bs. System controller 130 may be a single network entity or a collection of network entities.

A UE may perform a search to detect cells when the UE is first powered up, when the UE loses coverage, when the UE is idle, or when the UE is in active communication. The UE may perform the search based on known signals transmitted by each cell in the system. Different systems may utilize different synchronization and pilot signals/channels to assist searching by UEs. For clarity, synchronization and pilot signals/channels used for searches in WCDMA are described below.

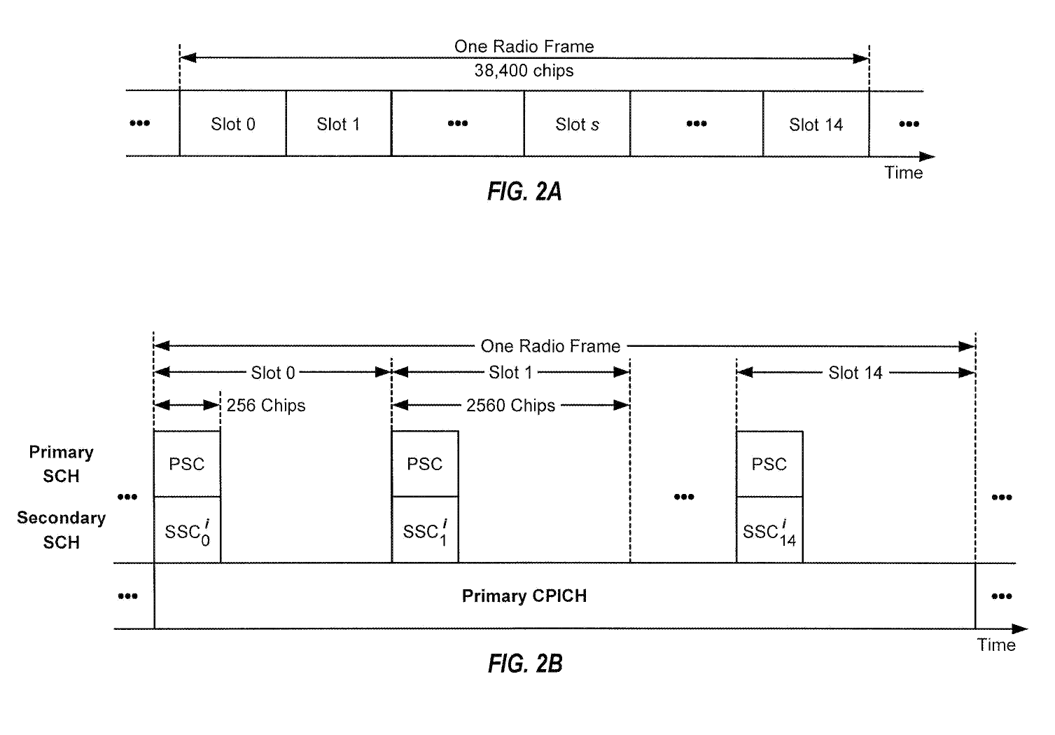

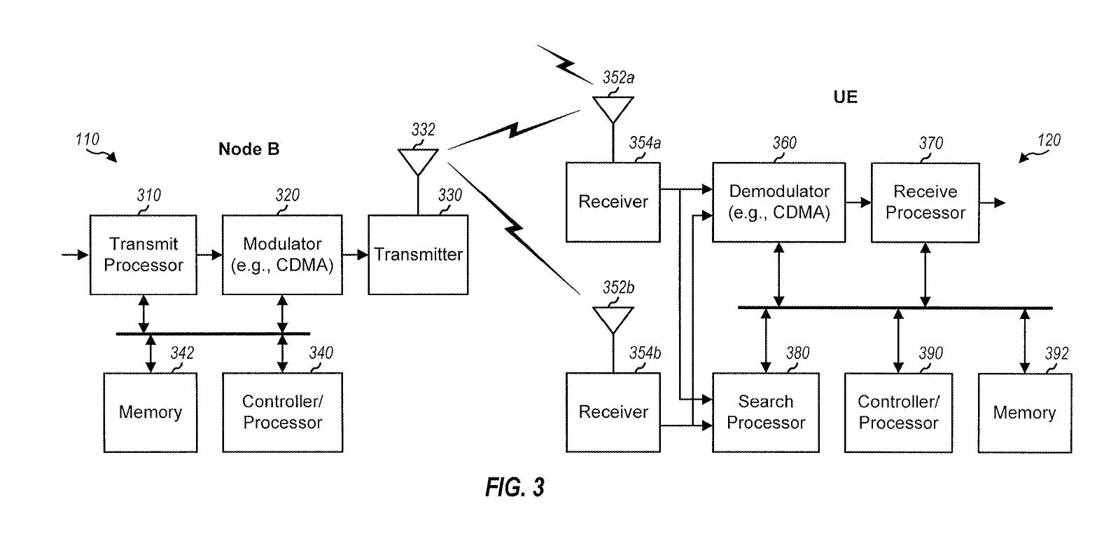

FIG. 2A shows a frame structure in WCDMA. The transmission timeline on the downlink is partitioned into units of radio frames. Each radio frame has a duration of 10 milliseconds (ms) and covers 38,400 chips. Each radio frame is further partitioned into 15 slots with indices of 0 through 14. Each slot has a duration of approximately 0.67 ms and covers 2560 chips.

FIG. 2B shows transmission of a synchronization channel (SCH) and a common pilot channel (CPICH) on the downlink by one cell in WCDMA. The SCH includes a primary SCH and a secondary SCH, which are transmitted in the first 256 chips of each 2560-chip slot. The primary SCH carries a 256-chip primary synchronization code (PSC) in the first 256 chips of each slot. The PSC is a predetermined sequence of 256 chips. All cells in the system use the same PSC.

The secondary SCH carries a sequence of 15 secondary synchronization codes (SSCs), which is also referred to as an SSC pattern, in the 15 slots of each radio frame. The SSC pattern is denoted as SSC₀ⁱ through SSC₁₄ⁱ, in FIG. 2B, where i is an index for a scrambling code group. Each SSC is a predetermined sequence of 256 chips and is selected from a set of 16 available 256-chip codes.

In WCDMA, there are 64 scrambling code groups, which are associated with 64 different SSC patterns. Each scrambling code group includes eight scrambling codes and is associated with a different SSC pattern. Each cell in the system is assigned a specific scrambling code that is used to scramble data sent by that cell on the downlink. Each cell is thus associated with a specific SSC pattern determined by its assigned scrambling code. Each cell transmits its SSC pattern on the secondary SCH in each radio frame. Each cell also transmits a continuous pilot on the CPICH using the scrambling code assigned to that cell. The CPICH carries a predetermined sequence of modulation symbols scrambled by the scrambling code.

The PSC, SSC, SCH and CPICH are described in a document 3GPP TS 25.211, entitled “Physical Channels and Mapping of Transport Channels onto Physical Channels (FDD),” which is publicly available.

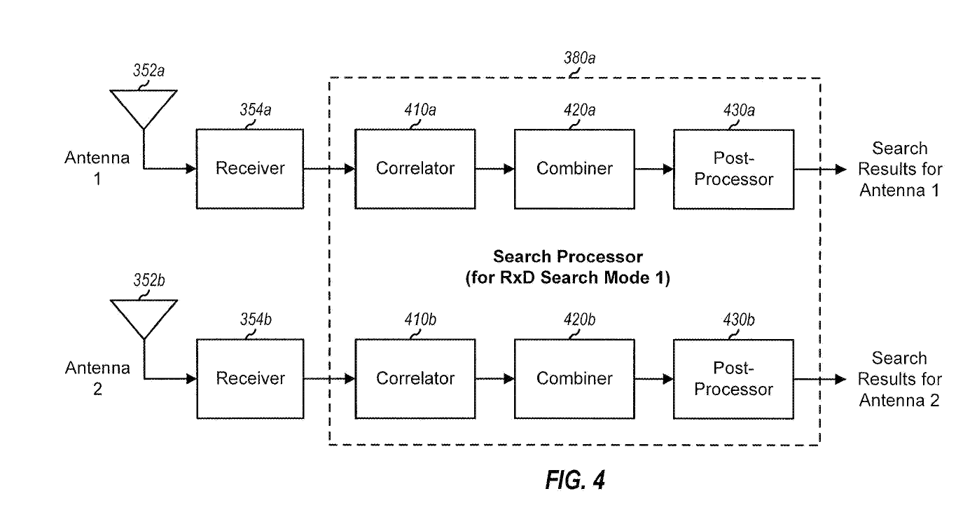

FIG. 3 shows a block diagram of an exemplary design of a Node B 110 and a UE 120, which may be one of the Node Bs and one of the UEs in FIG. 1. In the exemplary design shown in FIG. 3, Node B 110 is equipped with a single transmit antenna 332, and LIE 120 is equipped with two receive antennas 352a and 352b, which may be referred to as antennas 1 and 2, respectively. In general, Node B 110 and UE 120 may each be equipped with any number of antennas.

At Node B 110, a transmit processor 310 may receive traffic data for UEs being served and may process (e.g., encode, interleave, and symbol map) the traffic data to generate data symbols. Processor 310 may also generate overhead symbols for the primary SCH, the secondary SCH, and other overhead channels. Processor 310 may also generate pilot symbols for the CPICH. A modulator 320 may process the data symbols, the overhead symbols, and the pilot symbols (e.g., for CDMA) and may provide output samples to a transmitter 330. Modulator 320 may spread the symbols for each physical channel (except for SCH) with a channelization code for that channel, apply the scrambling code for a cell, scale the samples for each physical channel with a gain determined by the transmit power for that channel, and sum the scaled samples for these physical channels with the samples for the P-SCH and S-SCH, which have been scaled with gains determined by the transmit power for the P-SCH and S-SCH, to obtain the output samples. Transmitter 330 may process (e.g., convert to analog, amplify, filter, and frequency upconvert) the output samples and generate a downlink signal, which may be transmitted via antenna 332.

At UE 120, antennas 352a and 352b may receive the downlink signals from Node B 110 and other Node Bs. Each antenna 352 may provide a received signal to an associated receiver 354. Each receiver 354 may process (e.g., filter, amplify, frequency downconvert, and digitize) its received signal and may provide input samples to a demodulator 360 and a search processor 380. Search processor 380 may perform searches to detect cells and may provide search results for detected cells, as described below. Demodulator 360 may process the input samples in a manner complementary to the processing by modulator 320 and may provide symbol estimates, which may be estimates of the symbols transmitted by Node B 110. Demodulator 360 may implement a rake receiver that can process multiple signal instances in the received signal from each antenna 352 due to multiple signal paths between Node B 110 and that antenna. A receive processor 370 may process (e.g., symbol demap, deinterleave, and decode) the symbol estimates and may provide decoded data and signaling. In general, the processing by demodulator 360 and receive processor 370 at UE 120 may be complementary to the processing by modulator 320 and transmit processor 310, respectively, at Node B 110.

Controllers/processors 340 and 390 may direct the operation at Node B 110 and UE 120, respectively. Memories 342 and 392 may store data and program codes for Node B 110 and UE 120, respectively.

UE 120 may perform a search to detect cells and to ascertain the timing of detected cells. The UE may perform the search using various search processes. In general, the processing performed by the UE for the search may be dependent on the signals/channels transmitted by the cells. For clarity, the processing performed by the UE for the signals/channels shown in FIG. 2 is described below.

In a first search process, the UE may perform the search in three steps 1, 2 and 3 using the primary SCH, the secondary SCH, and the CPICH. The UE may perform each step as follows.

In step 1, the UE may search for the PSC transmitted on the primary SCH by correlating a received signal (or the input samples) at the UE with a locally generated PSC at different time offsets. For each time offset, the UE may correlate the received signal with the PSC at that time offset and may declare a detected PSC if the correlation result exceeds a detection threshold. The UE may thus use the primary SCH to detect the presence of a cell and to ascertain the slot timing of the cell.

In step 2, the UE may search for the SSCs transmitted on the secondary SCH to determine the SSC pattern used by each cell for which the PSC was detected. For a given detected cell, the UE may correlate the received signal in each slot with each of the 16 possible SSCs at the slot timing of the cell to determine which SSC was detected in that slot. The UE may obtain 15 detected SSCs for 15 consecutive slots. The UE may then ascertain which one of the 64 possible SSC patterns was transmitted based on the 15 detected SSCs in 15 consecutive slots. The UE can determine frame timing and the scrambling code group used for the detected cell based on the detected SSC pattern.

In step 3, the UE may process the CPICH to determine the scrambling code used by each cell for which the SSC pattern was detected. For a given detected cell, the UE may determine the eight possible scrambling codes associated with the detected SSC pattern for the cell. The UE may correlate the received signal with each of the eight possible scrambling codes at the frame timing of the cell and may declare a detected scrambling code if the correlation result exceeds a threshold. The UE may also perform correlation with the detected scrambling code for different time offsets to obtain an estimate of a channel impulse response for the detected cell.

In a second search process, the UE may perform a search in three steps A, B and C using the primary SCH and the CPICH. Step A may also be referred to as a cell detection step. Step B may also be referred to as a code detection step. Step C may also be referred to as a channel estimation step. The UE may perform each step as follows.

In step A, the UE may search for the PSC transmitted on the primary SCH by correlating a received signal with a locally generated PSC at different time offsets. The UE may detect the presence of a cell and ascertain the slot timing of the cell. Step A may correspond to step 1 above.

In step B, the UE may process the CPICH to determine the scrambling code used by each cell for which the PSC was detected. For a given detected cell, the UE may have 15 possible frame timing hypotheses based on the detected slot timing for the cell. The UE may evaluate each of the 512 possible scrambling codes at each of the 15 possible frame timing hypotheses. The UE may thus evaluate 7680 total hypotheses, with each hypothesis corresponding to a specific scrambling code at a specific frame timing. If a search window is used for each hypothesis, the UE may perform correlation over only a small search window covering just a few time offsets (e.g., a few chips) in order to reduce the amount of processing for step B. The UE may declare a detected scrambling code if a correlation result exceeds a threshold.

In step C, the UE may process the CPICH to estimate a channel impulse response for each cell for which the scrambling code was detected. For a given detected cell, the UE may correlate the received signal with the detected scrambling code at different time offsets within a larger search window (e.g., 128, 192 or 256 chips) to obtain the channel impulse response estimate for the detected cell. The channel impulse response may also be referred to as a channel profile, a path profile, etc. The search window may be placed at a location determined by the frame timing provided by step B, e.g., may be centered at the frame timing.

The two search processes described above may allow the UE to perform a search in incremental steps and to use the information obtained from each step for processing the next step. The first search process may allow the UE to more evenly partition the search into three steps. However, the first search process may take longer since step 2 utilizes the secondary SCH. Each cell transmits its SCH pattern once in each radio frame and further transmits each SSC in only 10 percent of a slot. The UE may be able to detect the SCH pattern after one radio frame but may need to accumulate over multiple radio frames (e.g., due to the low duty cycle of the SSC) in order to improve detection performance. The second search process may allow the UE to complete a search sooner and may also have improved performance since step B utilizes the CPICH, which is transmitted continuously and possibly at higher power than the secondary SCH. The UE may also perform a search using other search processes, which may partition the search in other manners.

The UE may be equipped with multiple receive antennas that may be used to receive signals from cells. Receive diversity (R×D) may be achieved by receiving a signal from a given cell via one or a combination of the multiple receive antennas. Receive diversity may improve performance.

In an aspect, multiple R×D search modes may be supported for searches. Each R×D search mode may be defined by how correlation is performed for multiple receive antennas, how correlation results for different antennas are combined, how search results are reported for the multiple receive antennas, etc. Different R×D search modes may have different characteristics, as described below. Each R×D search mode may be used for one or more steps of a search.

Table 1 lists three R×D search modes in accordance with one exemplary design. Table 1 provides a short description of each R×D search mode and also lists possible step(s) in which each R×D search mode might be used. Each R×D search mode is described in further detail below.

TABLE 1

| RxD Search | | |
|---|---|---|
| Mode | Description | Steps |
| RxD Search | Perform correlation for each receive antenna. | 3, C |
| Mode 1 | Combine correlation results separately for each | |
| | receive antenna. | |
| | Report correlation results separately for each | |
| | receive antenna. | |
| RxD Search | Perform correlation for each receive antenna. | 1, 2, |
| Mode 2 | Combine correlation results across receive antennas. | A, B |
| | Report combined correlation results for all receive | |
| | antennas. | |
| RxD Search | Perform correlation for each receive antenna. | |
| Mode 3 | Scale and combine correlation results across receive | |
| | antennas to cancel signals from interfering cells. | |
| | Report combined correlation results for all receive | |
| | antennas. | |

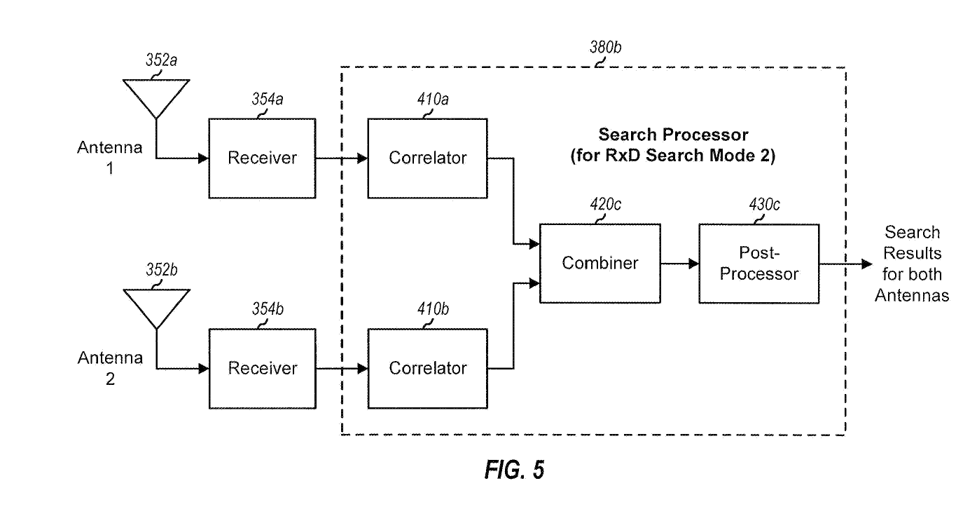

FIG. 4 shows a block diagram of a design of a search processor 380a for R×D search mode 1, which may be one configuration of search processor 380 in FIG. 3. Each receiver 354 may process a received signal from an associated antenna 352 and may provide input samples to an associated correlator 410 within search processor 380a. Each correlator 410 may perform correlation on its input samples with a code and provide correlation results. The code may be dependent on the type of search being performed and may be a PSC, an SSC, a scrambling code, etc. Although each signal path is illustrated as having its own corresponding hardware, it will be appreciated that in other designs the different signals may share the same hardware components and use them in a time division manner, for example.

The correlation by each correlator 410 may be expressed as:

$${C}_{m} ( k ) = {\sum }_{n = 0}^{N - 1} {r}_{m} ( n - k ) \cdot {c}^{*} ( n ) , \qquad Eq . ( 1 )$$

where rₘ(n) is an input sample for antenna m in sample period n,

c(n) is the code used for the correlation,

Cₘ (k) is a correlation result for antenna in at time offset k,

N is the number of input samples to correlate, and

“*” denotes a complex conjugate.

For correlation of the primary SCH (e.g., in step 1 or step A described above), c(n) may be the 256-chip sequence for the PSC, and N may be equal to 256. For correlation of the secondary SCH (e.g., in step 2), c(n) may be a 256-chip sequence for one SSC, and N may be equal to 256. For correlation of the CPICH (e.g., in step 3, step B, or step C), c(n) may be a scrambling code, and N may be equal to 128, 256, 512, 1024, 2048, 4096, etc. The input samples may be complex values, and the correlation result Cₘ (k) may be a complex value.

Each correlator 410 may perform correlation with code c(n) for different time offsets within a search window and may provide a correlation result for each time offset. Each correlator 410 may also perform correlation with code c(n) in different time intervals and may provide a set of correlation results for different time offsets in each time interval. The duration of each time interval may be dependent on the type of search being perform and may be one slot for the primary SCH, one frame for the secondary SCH, N chips for the CPICH, etc.

Each correlator 410 may provide its correlation results to an associated combiner 420. Each combiner 420 may coherently and/or non-coherently combine correlation results for each time offset. For each time offset, each combiner 420 may coherently combine correlation results obtained in different time intervals, as follows:

$${C}_{CC , m} ( k ) = {\sum }_{l} {C}_{m} ( k , l ) , \qquad Eq . ( 2 )$$

where Cₘ(k,l) is a correlation result for antenna in at time offset k in time interval l, and C_{CC,m}(k) is a coherently combined correlation result for antenna m at time offset k.

For each time offset, each combiner 420 may also non-coherently combine correlation results obtained in different time intervals, as follows:

$${C}_{NC , m} ( k ) = {\sum }_{l} {\vert {C}_{m} ( k , l ) \vert}^{2} , \qquad Eq . ( 3 )$$

where C_{NC,m}(k) is a non-coherently combined correlation result for antenna m at time offset k.

As shown in equation (2), coherent combining sums complex values such that the phases of the complex values affect the result. As shown in equation (3), non-coherent combining sums real energy values. Coherent and non-coherent combining may be used to average noise and improve the accuracy of the correlation results. Coherent combining may provide better performance but may be limited to situations in which a wireless channel has not changed noticeably, to avoid combining complex values with large phase difference. Non-coherent combining may be used for most situations. Both coherent and non-coherent combining may also be performed.

Each combiner 420 may compute the energy of the combined correlation result for each time offset, as follows:

Eₘ(k)=C_{NC,m}(k), or Eq. (4a)

Eₘ(k)=|C_{CC,m}(k)|², Eq. (4b)

where Eₘ(k) is the energy for antenna m at time offset k. Eₘ(k) is indicative of the strength of a signal path from a cell to antenna m at delay k.

Each post-processor 430 may sort the energies for different time offsets and may provide search results for its receive antenna. In one design, each post-processor 430 may identify each time offset with energy exceeding a particular threshold and may provide the energy and time offset. In another design, each post-processor 430 may provide the energy and time offset for L strongest peaks at L different time offsets, where L may be one or greater. The search results for each receive antenna may also comprise other information. The search results may be used to assign fingers of a rake receiver to process strong signal paths and/or for other purposes.

As shown in FIG. 4, correlator 410a, combiner 420a, and post-processor 430a may search on the first receive antenna 352a and may provide search results for this antenna. Similarly, correlator 410b, combiner 420b, and post-processor 430b may search on the second receive antenna 352b and may provide search results for this antenna. The search results for the two receive antennas may be reported separately. R×D search mode 1 may be especially useful for step 3 and step C to obtain a channel profile for each receive antenna for finger assignment.

FIG. 5 shows a block diagram of a design of a search processor 380b for R×D search mode 2, which may be another configuration of search processor 380 in FIG. 3. Each receiver may process a received signal from an associated antenna 352 and may provide input samples to an associated correlator 410 within search processor 380b. Each correlator 410 may perform correlation on its input samples with a code (e.g., a PSC, an SSC, or a scrambling code) at different time offsets and may provide correlation results for different time offsets, as described above.

A combiner 420c may receive correlation results from both correlators 410a and 410b and may combine the correlation results, as follows:

E(k)=|C_{CC,1}(k)|²+C_{CC,2}(k)|₂, or Eq. (5a)

E(k)=C_{NC,1}(k)+C_{NC,2}(k) Eq. (5b)

where E(k) is the total energy for the two receive antennas at time offset k.

Combiner 420c may obtain E(k) for different time intervals and may non-coherently combine E(k) across time intervals for each time offset k. Combiner 420c may then provide the energies for different time offsets to a post-processor 430c. Post-processor 430c may sort the energies for different time offsets and may provide search results together for both receive antennas. In one design, post-processor 430c may identify each time offset with energy exceeding a particular threshold and may provide the energy and time offset. In another design, post-processor 430c may provide the energy and time offset for L strongest peaks at L different time offsets. The search results for both receive antennas may also comprise other information.

In R×D search mode 2, the search results are provided for both receive antennas, and the two antennas cannot be distinguished from the search results. If the signal paths on the two receive antennas are close together, then R×D search mode 2 may increase the peak energy. R×D search mode 2 may be especially useful for step 1, step 2, step A, and step B since a primary purpose of these steps is to detect codes and timing, and the peaks from individual antennas are not important. In particular, the main purpose of step 1 and step A may be high probability of detection of slot boundaries. The main purpose of step 2 and step B may be high probability of detection of frame timing and either SSC pattern (step 2) or scrambling code (step B). If the peak energies are improved due to combining across receive antennas, then the probability of detection for steps 1, 2, A and B may improve.

FIG. 6 shows a block diagram of a design of a search processor 380c for R×D search mode 3, which may be yet another configuration of search processor 380 in FIG. 3. Each receiver 354 may process a received signal from an associated antenna 352 and may provide input samples to an associated correlator 410 within search processor 380c. Each correlator 410 may perform correlation on the input samples with a code (e.g., the PSC, an SSC, or a scrambling code) at different time offsets and may provide correlation results for different time offsets, as described above.

R×D search mode 3 performs interference cancellation to attenuate signals from interfering cells. The interference cancellation may be achieved by (i) multiplying the input samples for each receive antenna with a complex weight for that antenna and (ii) combining the weighted samples for the two receive antennas, as follows:

r(n)=α·r₁(n)+β·r₂(n), Eq. (6)

where α is a complex weight for antenna 1, and β is a complex weight for antenna 2.

The complex weights α and β for the two receive antennas may be selected to attenuate the signals from interfering cells. Correlation may then be performed on the weighted samples r(n) in a similar manner as the input samples to obtain a correlation result C(k) for the two receive antennas. Correlation may thus be performed for all receive antennas with a complex weight applied to each receive antenna.

The complex weights α and β may be assumed to be constant for the duration of correlation. In this case, correlation may be performed on the input samples for each receive antenna m to obtain a correlation result Cₘ(k) for that antenna. The correlation results for the two receive antennas may then be multiplied with the complex weights and then combined, as follows:

C(k)=α·C₁(k)+β·C₂(k). Eq. (7)

Applying the complex weights α and β to the correlation results as shown in equation (7), instead of to the input samples as shown in equation (6), may reduce the number of multiply operations to achieve interference cancellation and may provide equivalent combined correlation results C(k) when the complex weights are approximately constant for the duration of the correlation.

As shown in FIG. 6, correlator 410a may provide correlation results C₁(k) for antenna 1 at different time offsets to a multiplier 412a, which may also receive the complex weight a from a weight computation unit 440. Multiplier 412a may multiply each correlation result with the weight α and may provide the weighted correlation result to a combiner 420d. Similarly, correlator 410b may provide correlation results C₂(k) for antenna 2 at different time offsets to a multiplier 412b, which may also receive the complex weight β from computation unit 440. Multiplier 412b may multiply each correlation result with the weight β and may provide the weighted correlation result to combiner 420d.

Combiner 420d may receive the weighted correlation results from both multipliers 412a and 412b and may combine the weighted correlation results, e.g., as shown in equation (7). Combiner 420d may obtain combined correlation results C(k) for different time intervals and may non-coherently combine C(k) across time intervals for each time offset k. Combiner 420d may then compute the energies of the combined correlation results and may provide the energies for different time offsets to a post-processor 430d. Post-processor 430d may sort the energies for different time offsets and may provide search results for both receive antennas. In one design, post-processor 430d may identify each time offset with energy exceeding a particular threshold and may provide the energy and time offset. In another design, post-processor 430d may provide the energy and time offset for L strongest peaks at L different time offsets. The search results for both receive antennas may also comprise other information.

Computation unit 440 may compute and provide the complex weights α and β for the two receive antennas. Computation unit 440 may determine the complex weights in various manners. In one design, computation unit 440 may determine a 2×2 correlation matrix R, as follows:

$$R = [ \begin{matrix}Avg \{ {r}_{1} ( n ) \cdot {r}_{1}^{*} ( n ) \} & Avg \{ {r}_{1} ( n ) \cdot {r}_{2}^{*} ( n ) \} \\ Avg \{ {r}_{2} ( n ) \cdot {r}_{1}^{*} ( n ) \} & Avg \{ {r}_{2} ( n ) \cdot {r}_{2}^{*} ( n ) \}\end{matrix} ] , \qquad Eq . ( 8 )$$

where Avg {r(n)·rⱼ*(n)} denotes an average of the correlation between the input samples for antenna i and the input samples for antenna j, where iε{1, 2} and jε{1, 2}. Avg {rᵢ(n)·rⱼ*(n)} may be obtained by multiplying rᵢ(n) with rⱼ*(n) and averaging the resultant product over a sufficient number of samples. Matrix R includes four complex values in two rows and two columns.

Computation unit 440 may perform eigenvalue decomposition of matrix R, as follows:

R=EΛE^{H}, Eq. (9)

where E is a 2×2 unitary matrix of eigenvectors of R,

Λ is a 2×2 diagonal matrix of eigenvalues of R, and

“^{H}” denotes a Hermitian or conjugate transpose.

Unitary matrix E is characterized by the property E_{H} E=I, where I is an identity matrix. The columns of E are orthogonal to one another, and each column has unit power. Diagonal matrix Λ includes positive values along the diagonal and zeros elsewhere for non-degenerate cases where R is positive definite. The diagonal elements of Λ are eigenvalues of R. The smallest eigenvalue value in Λ may be identified, and the eigenvector corresponding to this smallest eigenvalue value may be selected. The selected eigenvector may be (i) the first column of E if the upper left element of Λ is smaller than the lower right element of Λ or (ii) the second column of E if the lower right element of Λ is smaller than the upper left element of Λ. The complex conjugate of the two entries in the selected eigenvector may be provided as the two complex weights α and β.

In R×D search mode 3, interference cancellation may be performed to enable or improve detection of a signal from a cell. In one design, interfering cells may be identified and the complex weights may be computed to attenuate the signals from these cells. In another design, interfering cells may be identified, and interference cancellation may be performed for each identified cell, e.g., successively for one cell at a time.

R×D search mode 3 may be used for any of the steps described above for the first and second search processes. R×D search mode 3 may be especially useful for correlation with a scrambling code for a weak detected cell.

R×D search mode 3 may be used to search for cells for positioning. For example, R×D search mode 3 may be used to measure time of arrival (TOA) of signals from different cells. The TOAs may be used to determine observed time difference of arrival (OTDOA) for pairs of cells. OTDOAs for a sufficient number of pairs of cells (e.g., two or more pairs of cells) and the known location of the cells may be used to derive a location estimate for the UE using trilateration.

Three exemplary R×D search modes have been described above. Other R×D search modes may also be supported and may perform correlation, combining, and/or reporting in other manners. Different R×D search modes may be used for different types of searches, e.g., depending on the purposes of the searches. For example, R×D search mode 2 may be used for steps A and B of the second search process in order to detect slot and frame timing and to determine a scrambling code. R×D search mode 1 may be used for step C of the second search process to determine a channel profile for each receive antenna.

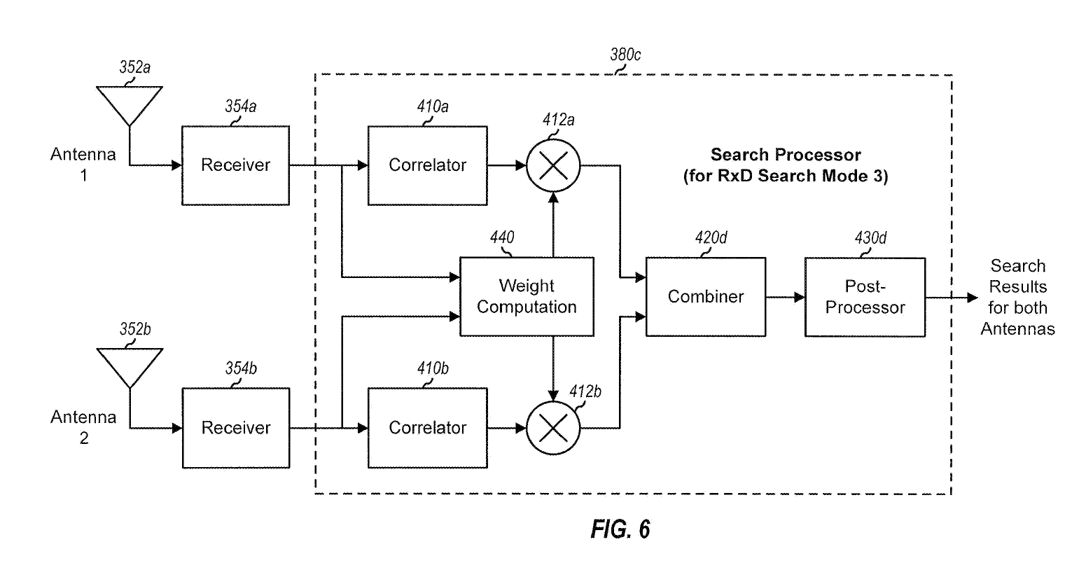

FIG. 7 shows a design of a process 700 for performing a search by a UE with multiple receive antennas. The UE may select an R×D search mode from among multiple R×D search modes supported by the UE (block 712). Each R×D search mode may be different from each remaining R×D search mode in (i) correlation for the multiple receive antennas, (ii) combining of correlation results for the multiple receive antennas, (iii) reporting of search results for the multiple receive antennas, or (iv) a combination thereof. For example, one R×D search mode may perform correlation for the multiple receive antennas differently than another R×D search mode and/or combine correlation results for the multiple receive antennas differently than yet another R×D search mode. In any case, the UE may perform at least one step of a search in accordance with the selected R×D search mode (block 714).

The multiple R×D search modes may include R×D search mode 1 in which correlation is performed separately for each receive antenna, correlation results are combined separately for each receive antenna, and search results are reported separately for each receive antenna. The multiple R×D search modes may include R×D search mode 2 in which correlation is performed separately for each receive antenna, correlation results for the multiple receive antennas are combined, and search results are reported together for all receive antennas. The multiple R×D search modes may include R×D search mode 3 in which correlation is performed for all receive antennas with a complex weight applied to each receive antenna, correlation results for the multiple receive antennas are combined, and search results are reported together for all receive antennas. The complex weight for each receive antenna may be determined to attenuate signals from interfering cells to enable or improve detection of a signal from another cell. The multiple R×D search modes may also include different and/or additional R×D search modes.

In one design, the search may include a cell detection step (e.g., step A) to detect cells and to determine slot timing of each detected cell. The cell detection step may be performed in accordance with the selected R×D search mode, which may be R×D search mode 2. In one design, the UE may correlate input samples for each receive antenna with a PSC to obtain a correlation result for the receive antenna. The UE may combine correlation results for the multiple receive antennas to obtain a combined correlation result. The UE may repeat the process for each time offset or sample period. The UE may then determine search results (e.g., a detected cell, slot timing, etc.) based on combined correlation results for different time offsets.

In one design, the search may include a code detection step (e.g., step B) to determine a scrambling code used by a detected cell. The code detection step may be performed in accordance with the selected R×D search mode, which may be R×D search mode 2. In one design, the UE may correlate input samples for each receive antenna with each of a plurality of (e.g., 512) possible scrambling codes to obtain a plurality of correlation results for the plurality of possible scrambling codes for the receive antenna. The UE may combine correlation results for the multiple receive antennas for each scrambling code to obtain a combined correlation result for the scrambling code. The UE may repeat the correlation and combining for each of a plurality of (e.g., 15) frame timing hypotheses and may obtain a plurality of combined correlation results for the plurality of frame timing hypotheses for each scrambling code and each receive antenna. The UE may then determine search results (e.g., a scrambling code, frame timing, etc.) based on all combined search results.

In one design, the search may include a channel estimation step (e.g., step C) to determine a channel profile for each receive antenna for a detected cell. The channel estimation step may be performed in accordance with the selected R×D search mode, which may be R×D search mode 1. In one design, the UE may correlate input samples for each receive antenna with a scrambling code for the detected cell at a plurality of time offsets to obtain a plurality of correlation results for the plurality of time offsets for the receive antenna. The UE may combine correlation results obtained in different time intervals for each time offset and each receive antenna. The UE may then determine search results (e.g., a channel profile) for each receive antenna based on a plurality of combined correlation results for the plurality of time offsets for that receive antenna.

FIG. 8 shows a design of a process 800 for performing a search by a UE with multiple receive antennas. The UE may perform a first step of a search in accordance with a first R×D search mode (block 812). The UE may perform a second step of the search in accordance with a second R×D search mode (block 814). The second R×D search mode may be different from the first R×D search mode in correlation for the multiple receive antennas, combining of correlation results for the multiple receive antennas, reporting of search results for the multiple receive antennas, or a combination thereof.

In one design, for the first R×D search mode, the UE may perform correlation separately for each receive antenna, combine correlation results for the multiple receive antennas, and report search results together for all receive antennas. In one design, for the second R×D search mode, the UE may perform correlation separately for each receive antenna, combine correlation results separately for each receive antenna, and report search results separately for each receive antenna. The first and second R×D search modes may also perform correlation, combing, and/or reporting in other manners.

In one design, the first step of the search may comprise (i) detecting cells and determining the slot timing of each detected cell or (ii) determining a scrambling code used by a detected cell. In one design, the second step of the search may comprise determining a channel profile for each receive antenna for a detected cell. The first and second steps may also comprise other actions.

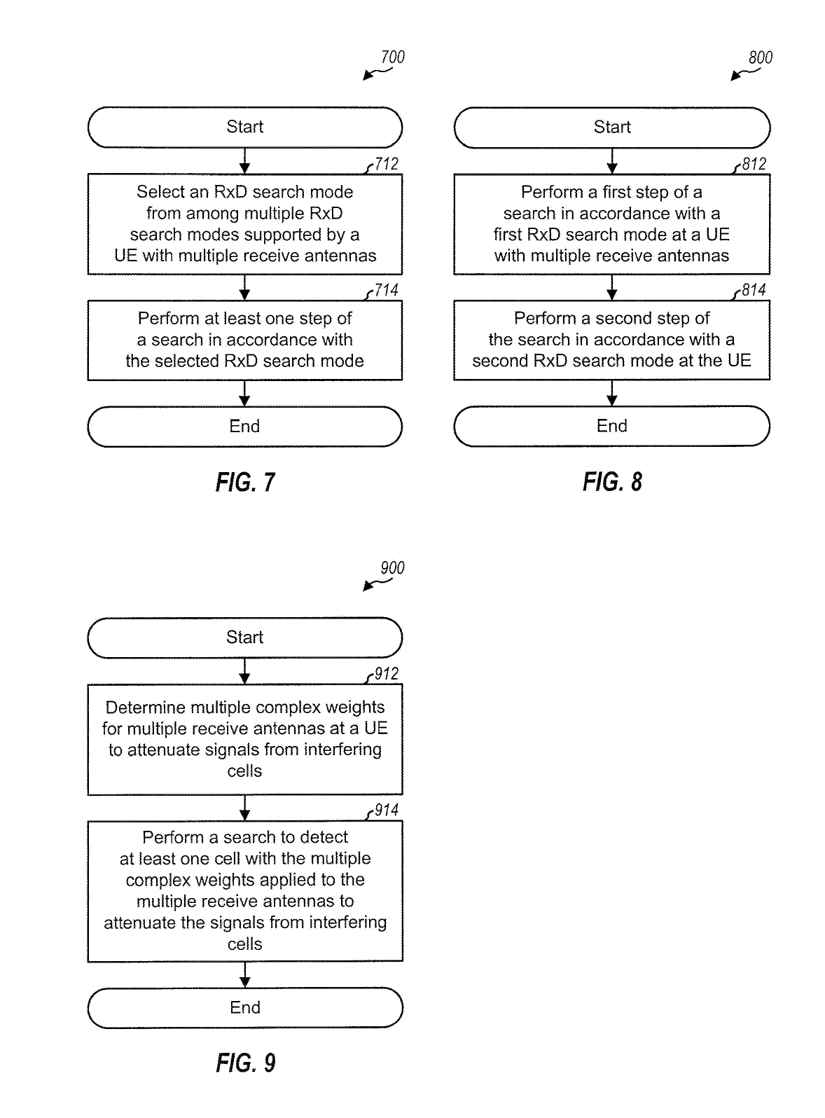

FIG. 9 shows a design of a process 900 for performing a search with interference cancellation by a UE with multiple receive antennas. The UE may determine multiple complex weights for multiple receive antennas to attenuate signals from interfering cells (block 912). The UE may then perform a search to detect at least one cell with the multiple complex weights applied to the multiple receive antennas to attenuate the signals from interfering cells (block 914).

In one design of block 912, the UE may obtain a correlation matrix based on input samples for the multiple receive antennas, e.g., as shown in equation (8). The UE may decompose the correlation matrix (e.g., with eigenvalue decomposition) to obtain a first matrix of eigenvalues and a second matrix of eigenvectors, e.g., as shown in equation (9). The UE may identify an eigenvector in the second matrix associated with a smallest eigenvalue in the first matrix. The UE may then use the complex conjugate of the elements of the identified eigenvector as the multiple complex weights for the multiple receive antennas.

In one design of block 914, the UE may correlate input samples for each receive antenna with a scrambling code for a detected cell to obtain a correlation result for the receive antenna. The UE may multiply the correlation result for each receive antenna with a complex weight for the receive antenna. The UE may then combine the weighted correlation results for the multiple receive antennas to obtain a combined correlation result, e.g., as shown in equation (7). Equivalently, the UE may multiply the input samples for each receive antenna with the complex weight for that antenna. The UE may combine the weighted samples for all receive antennas, e.g., as shown in equation (6). The UE may then perform correlation based on the combined samples.

The UE may obtain at least one time measurement for at least one cell based on the search. A location estimate for the UE may be obtained based on the at least one time measurement for the at least one cell. The UE may also obtain other search results and/or may use the search results in other manners for other purposes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
selecting a receive diversity (R×D) search mode from among multiple R×D search modes supported by a user equipment (UE) with multiple receive antennas, each R×D search mode being different from each remaining R×D search mode in at least one of correlation for the multiple receive antennas, combining of correlation results for the multiple receive antennas, and reporting of search results for the multiple receive antennas; and
performing at least one step of a search in accordance with the selected R×D search mode.

2. The method of claim 1, wherein the multiple R×D search modes include an R×D search mode in which correlation is performed separately for each receive antenna, correlation results are combined separately for each receive antenna, and search results are reported separately for each receive antenna.

3. The method of claim 1, wherein the multiple R×D search modes include an R×D search mode in which correlation is performed separately for each receive antenna, correlation results for the multiple receive antennas are combined, and search results are reported together for all receive antennas.

4. The method of claim 1, wherein the multiple R×D search modes include an R×D search mode in which correlation is performed for all receive antennas with a complex weight applied to each receive antenna, correlation results for the multiple receive antennas are combined, and search results are reported together for all receive antennas.

5. The method of claim 4, further comprising:
determining the complex weight for each receive antenna to attenuate signals from interfering cells to enable or improve detection of a signal from another cell.

6. The method of claim 1, wherein the search comprises a cell detection step to detect at least one cell and to determine slot timing of each detected cell, and wherein the performing at least one step of the search comprises performing the cell detection step in accordance with the selected R×D search mode.

7. The method of claim 6, wherein the performing the cell detection step in accordance with the selected R×D search mode comprises:
correlating input samples for each receive antenna with a primary synchronization code (PSC) to obtain a correlation result for the receive antenna;
combining correlation results for the multiple receive antennas to obtain a combined correlation result; and
determining search results based on the combined correlation result.

8. The method of claim 1, wherein the search comprises a code detection step to determine a scrambling code used by a detected cell, and wherein the performing at least one step of the search comprises performing the code detection step in accordance with the selected R×D search mode.

9. The method of claim 8, wherein the performing the code detection step in accordance with the selected R×D search mode comprises:
correlating input samples for each receive antenna with each of a plurality of possible scrambling codes to obtain a plurality of correlation results for the plurality of possible scrambling codes for the receive antenna;
combining correlation results for the multiple receive antennas for each scrambling code to obtain a combined correlation result for the scrambling code; and
determining search results based on a plurality of combined correlation results for the plurality of scrambling codes.

10. The method of claim 8, wherein the performing the code detection step in accordance with the selected R×D search mode comprises:
correlating input samples for each receive antenna for each of a plurality of frame timing hypotheses to obtain a plurality of correlation results for the plurality of frame timing hypotheses for the receive antenna;
combining correlation results for the multiple receive antennas for each frame timing hypothesis to obtain a combined correlation result for the frame timing hypothesis; and
determining search results based on a plurality of combined correlation results for the plurality of frame timing hypotheses.

11. The method of claim 8, wherein the performing the code detection step in accordance with the selected R×D search mode comprises:
correlating input samples for each receive antenna with each of a plurality of possible scrambling codes to obtain a plurality of correlation results for the plurality of possible scrambling codes for the receive antenna;
combining correlation results for the multiple receive antennas for each scrambling code to obtain a combined correlation result for the scrambling code;
repeating the correlating and the combining for each of a plurality of frame timing hypotheses; and
determining search results based on a plurality of combined correlation results for the plurality of scrambling codes for each of the plurality of frame timing hypotheses.

12. The method of claim 1, wherein the search comprises a channel estimation step to determine a channel profile for each receive antenna for a detected cell, and wherein the performing at least one step of the search comprises performing the channel estimation step in accordance with the selected R×D search mode.

13. The method of claim 12, wherein the performing the channel estimation step in accordance with the selected R×D search mode comprises:
correlating input samples for each receive antenna with a scrambling code for the detected cell at a plurality of time offsets to obtain a plurality of correlation results for the plurality of time offsets for the receive antenna;
combining correlation results obtained in different time intervals for each time offset and each receive antenna; and
determining search results for each receive antenna based on a plurality of combined correlation results for the plurality of time offsets for the receive antenna.

14. The method of claim 1, further comprising:
selecting a second receive diversity (R×D) search mode from among the multiple R×D search modes supported by the UE; and
performing at least one other step of the search in accordance with the selected second R×D search mode.

15. An apparatus for wireless communication, comprising:
means for selecting a receive diversity (R×D) search mode from among multiple R×D search modes supported by a user equipment (UE) with multiple receive antennas, each R×D search mode being different from each remaining R×D search mode in at least one of correlation for the multiple receive antennas, combining of correlation results for the multiple receive antennas, and reporting of search results for the multiple receive antennas; and
means for performing at least one step of a search in accordance with the selected R×D search mode.

16. The apparatus of claim 15, wherein the multiple R×D search modes include an R×D search mode in which correlation is performed separately for each receive antenna, correlation results are combined separately for each receive antenna, and search results are reported separately for each receive antenna.

17. The apparatus of claim 15, wherein the multiple R×D search modes include an R×D search mode in which correlation is performed separately for each receive antenna, correlation results for the multiple receive antennas are combined, and search results are reported together for all receive antennas.

18. The apparatus of claim 15, wherein the multiple R×D search modes include an R×D search mode in which correlation is performed for all receive antennas with a complex weight applied to each receive antenna, correlation results for the multiple receive antennas are combined, and search results are reported together for all receive antennas.

19. An apparatus for wireless communication, comprising:
at least one processor configured to select a receive diversity (R×D) search mode from among multiple R×D search modes supported by a user equipment (UE) with multiple receive antennas, each R×D search mode being different from each remaining R×D search mode in at least one of correlation for the multiple receive antennas, combining of correlation results for the multiple receive antennas, and reporting of search results for the multiple receive antennas, and to perform at least one step of a search in accordance with the selected R×D search mode.

20. The apparatus of claim 19, wherein the multiple R×D search modes include an R×D search mode in which correlation is performed separately for each receive antenna, correlation results are combined separately for each receive antenna, and search results are reported separately for each receive antenna.

21. The apparatus of claim 19, wherein the multiple R×D search modes include an R×D search mode in which correlation is performed separately for each receive antenna, correlation results for the multiple receive antennas are combined, and search results are reported together for all receive antennas.

22. The apparatus of claim 19, wherein the multiple R×D search modes include an R×D search mode in which correlation is performed for all receive antennas with a complex weight applied to each receive antenna, correlation results for the multiple receive antennas are combined, and search results are reported together for all receive antennas.

23. A computer-readable storage medium comprising code, which, when executed by a computer, causes the computer to perform operations for wireless communication, the computer-readable storage medium comprising:
code for causing the computer to select a receive diversity (R×D) search mode from among multiple R×D search modes supported by a user equipment (UE) with multiple receive antennas, each R×D search mode being different from each remaining R×D search mode in at least one of correlation for the multiple receive antennas, combining of correlation results for the multiple receive antennas, and reporting of search results for the multiple receive antennas, and
code for causing the computer to perform at least one step of a search in accordance with the selected R×D search mode.

24. A method for wireless communication, comprising:
performing a first step of a search in accordance with a first receive diversity (R×D) search mode at a user equipment (UE) with multiple receive antennas; and
performing a second step of the search in accordance with a second R×D search mode at the UE, the second R×D search mode being different from the first R×D search mode in at least one of correlation for the multiple receive antennas, combining of correlation results for the multiple receive antennas, and reporting of search results for the multiple receive antennas.

25. The method of claim 24, wherein for the first R×D search mode, correlation is performed separately for each receive antenna, correlation results for the multiple receive antennas are combined, and search results are reported together for all receive antennas.

26. The method of claim 24, wherein for the second R×D search mode, correlation is performed separately for each receive antenna, correlation results are combined separately for each receive antenna, and search results are reported separately for each receive antenna.

27. The method of claim 24, wherein the performing the first step of the search comprises detecting at least one cell and determining slot timing of each detected cell.

28. The method of claim 24, wherein the performing the first step of the search comprises determining a scrambling code used by a detected cell.

29. The method of claim 24, wherein the performing the second step of the search comprises determining a channel profile for each receive antenna for a detected cell.

30. An apparatus for wireless communication, comprising:
means for performing a first step of a search in accordance with a first receive diversity (R×D) search mode at a user equipment (UE) with multiple receive antennas; and
means for performing a second step of the search in accordance with a second R×D search mode at the UE, the second R×D search mode being different from the first R×D search mode in at least one of correlation for the multiple receive antennas, combining of correlation results for the multiple receive antennas, and reporting of search results for the multiple receive antennas.

31. The apparatus of claim 30, wherein for the first R×D search mode, correlation is performed separately for each receive antenna, correlation results for the multiple receive antennas are combined, and search results are reported together for all receive antennas.

32. The apparatus of claim 30, wherein for the second R×D search mode, correlation is performed separately for each receive antenna, correlation results are combined separately for each receive antenna, and search results are reported separately for each receive antenna.

33. An apparatus for wireless communication, comprising:
at least one processor configured to perform a first step of a search in accordance with a first receive diversity (R×D) search mode at a user equipment (UE) with multiple receive antennas, and to perform a second step of the search in accordance with a second R×D search mode at the UE, the second R×D search mode being different from the first R×D search mode in at least one of correlation for the multiple receive antennas, combining of correlation results for the multiple receive antennas, and reporting of search results for the multiple receive antennas.

34. A computer-readable storage medium comprising code, which, when executed by a computer, causes the computer to perform operations for wireless communication, the computer-readable storage medium comprising:
code for causing the computer to perform a first step of a search in accordance with a first receive diversity (R×D) search mode at a user equipment (UE) with multiple receive antennas; and
code for causing the computer to perform a second step of the search in accordance with a second R×D search mode at the UE, the second R×D search mode being different from the first R×D search mode in at least one of correlation for the multiple receive antennas, combining of correlation results for the multiple receive antennas, and reporting of search results for the multiple receive antennas.

35. A method for wireless communication, comprising:
determining multiple complex weights for multiple receive antennas at a user equipment (UE) to attenuate signals from interfering cells; and
performing a search to detect at least one cell with the multiple complex weights applied to the multiple receive antennas to attenuate the signals from interfering cells.

36. The method of claim 35, wherein the determining the multiple complex weights for the multiple receive antennas comprises:
obtaining a correlation matrix based on input samples for the multiple receive antennas;
decomposing the correlation matrix to obtain a first matrix of eigenvalues and a second matrix of eigenvectors;
identifying an eigenvector in the second matrix associated with a smallest eigenvalue in the first matrix; and
using the complex conjugates of the elements of the identified eigenvector as the multiple complex weights for the multiple receive antennas.

37. The method of claim 35, wherein the performing the search comprises:
correlating input samples for each receive antenna with a scrambling code for a detected cell to obtain a correlation result for the receive antenna;
multiplying the correlation result for each receive antenna with a complex weight for the receive antenna; and
combining weighted correlation results for the multiple receive antennas to obtain a combined correlation result.

38. The method of claim 35, further comprising:
obtaining at least one time measurement for the at least one cell based on the search; and
obtaining a location estimate for the UE based on the at least one time measurement for the at least one cell.

39. An apparatus for wireless communication, comprising:
means for determining multiple complex weights for multiple receive antennas at a user equipment (UE) to attenuate signals from interfering cells; and
means for performing a search to detect at least one cell with the multiple complex weights applied to the multiple receive antennas to attenuate signals from the interfering cells.

40. The apparatus of claim 39, wherein the means for determining the multiple complex weights for the multiple receive antennas comprises:
means for obtaining a correlation matrix based on input samples for the multiple receive antennas;
means for decomposing the correlation matrix to obtain a first matrix of eigenvalues and a second matrix of eigenvectors;
means for identifying an eigenvector in the second matrix associated with a smallest eigenvalue in the first matrix; and
means for using the complex conjugates of the elements of the identified eigenvector as the multiple complex weights for the multiple receive antennas.

41. The apparatus of claim 39, wherein the means for performing the search comprises:
means for correlating input samples for each receive antenna with a scrambling code for a detected cell to obtain a correlation result for the receive antenna;
means for multiplying the correlation result for each receive antenna with a complex weight for the receive antenna; and
means for combining weighted correlation results for the multiple receive antennas to obtain a combined correlation result.

42. An apparatus for wireless communication, comprising:
at least one processor configured to determine multiple complex weights for multiple receive antennas at a user equipment (UE) to attenuate signals from interfering cells, and to perform a search to detect at least one cell with the multiple complex weights applied to the multiple receive antennas to attenuate signals from the interfering cells.

43. A computer-readable storage medium comprising code, which, when executed by a computer, causes the computer to perform operations for wireless communication, the computer-readable storage medium comprising:
code for causing the computer to determine multiple complex weights for multiple receive antennas at a user equipment (UE) to attenuate signals from interfering cells; and
code for causing the computer to perform a search to detect at least one cell with the multiple complex weights applied to the multiple receive antennas to attenuate signals from the interfering cells.
